(19) United States
(12) Patent Application Publication
(10) Pub. No.: US 2012/0010931 A1
(43) Pub. Date: Jan. 12, 2012

(54) MOBILE PHONE BASED MOBILE CUSTOMER RELATIONSHIP LOYALTY METHODOLOGY AND SERVICING SYSTEM WITH INSTANT ANALYTICS FEATURES THEREOF

(75) Inventors: Krishna Kumar Mehra, Kolkata (IN); Aneesh Reddy Boddu, Hyderabad (IN); Ajay Modani, Jhalawar (IN)

(73) Assignee: Krishna Kumar MEHRA, Kolkata (IN)

(21) Appl. No.: 13/257,630

(22) PCT Filed: Mar. 17, 2010
(86) PCT No.: PCT/IN2010/000155

§ 371 Date: Sep. 20, 2011

(30) Foreign Application Priority Data
Mar. 20, 2009 (IN) 500/KOL/2009

(51) Int. Cl. G06Q 30/00

(52) U.S. Cl. 705/14.16; 705/14.27

(57) ABSTRACT

A mobile phone based mobile customer relationship and loyalty servicing system and method thereof which involves media such as SMS, e-mail, instant messenger or a notification to a mobile application or website as well to identify and communicate with the customer in a customer friendly manner. It includes a unique code based operation and special feature of instant analytics for the customer, points/voucher validation and redemption, incentivized referral program, integrated campaigns and the like right at the POS terminal at client outlet enabling real time integration, analytics and communication. The system involving Mobile phones/like mobile operative devices of the end users/customers, at least one client component at the retail/sales outlets and a server component comprising an MCRLP main server system for operative connection to said one client component for customer relationship and loyalty servicing. The Customer interacts with the system and his behavior is modeled.

### FIELD OF THE INVENTION

The present invention relates to a mobile customer relationship, engagement and loyalty servicing and, in particular, to a mobile phone based mobile customer relationship and loyalty methodology and servicing system thereof. Importantly, the invention is directed to favour immediate communication with the customer as soon as they shop using their mobile phones involving media such as SMS, e-mail, instant messenger etc. and thereby favour a more customer friendly customer relationship and loyalty servicing. The system described herein also has the special feature of being able to do instant analytics for the customer as soon as they shop in the store. The Mobile Customer Relationship and Loyalty Program solution described in this invention may hereinafter be abbreviated to MCRLP for the sake of brevity.

According to the system of the invention the Retail Client is the organization that owns the system and runs it in either in their own premises, or as a hosted solution with a solution provider (in different configurations). The Customer is the end consumer that interacts with the system and whose behavior is being modeled. In the exposition that follows, the means of communication is mentioned as SMS (short message service) in most cases, but can in general also be email, Instant Message, a notification to a mobile application or website as well.

### BACKGROUND ART

Loyalty Programs are in vogue In the industry because they help retain customers and increase the share of the wallet by giving the customers a reason to visit a store again and again. This relationship building process of late has been automated by using computers to enable communication and bookkeeping of points, using software called Customer Relationship Management (CRM) software. Most programs work by allocating “points” or virtual currency to the customers whenever they make a purchase. These points are arrived at in an algorithmic fashion from the bill data (eg., bill amount, number of items bought) and the customer's history (customer category or “slab” the customer is in). These points can then be redeemed in future purchases. CRM software may also contain modules to analyze customer data and run campaigns, or these may be provided as separate systems that are loosely integrated. This software traditionally uses a card to allot a unique identification number to a customer that is used in the bookkeeping process, and to identify the customer at the time of redemptions.

Typical architecture of the billing or Point of Sale (POS) systems at this point have a component installed at the billing terminals which is called the POS component. All the data flows back to the central server that hosts the back-end software for managing data across all stores, typically called the Head Office (HO) module. Traditionally, the way CRM programs operate is by collating data about customer purchases at the end of the day from the HO module in a “batch” process. The CRM program then collates the points and enables the redemptions for future purchase. There may be some other manifestations of this system where the data flows from the POS module to the HO module and thereon to the CRM system at regular intervals. However, the system never analyzes data in an instant fashion. Besides, since the data is synchronized in a “batch” process, mobile vouchers can't get invalidated, and hence its difficult to run fraud-proof campaigns in most scenarios.

There are also standard data analytics and reporting engines that are readily available for generating insights from the data. Simple reports can be generated using a spreadsheet program like Microsoft Excel, or using a database engine. More detailed reports with richer drill-up and drill-down features are available using hypercubes and multi-dimensional databases. Also, there are standard data mining tools that include clustering, classification engines using different algorithms and predictive modeling that are widely used to improve the data mining capability.

### OBJECTS OF THE INVENTION

It is thus the basic object of the present invention to provide for a mobile customer relationship and loyalty servicing and in particular to a mobile phone based mobile customer relationship and, loyalty methodology and servicing system thereof which would benefit a more customer friendly customer relationship and loyalty servicing.

Another object of the present invention is directed to provide for a mobile customer relationship and loyalty servicing and in particular to a mobile phone based mobile customer relationship and loyalty methodology and servicing system thereof which would not require the need for any other unique identification number such as those required in case of any card based software access known in the art and favour simple application of mobile phones of customers to maintain points and also provide for methodology/system for validation protocols and techniques. The same may also be supported in some configurations with an alternate identification which is tagged to the mobile phone number.

Another object of the present invention is directed to a mobile phone based mobile customer relationship and loyalty methodology and servicing system thereof whereby It would be possible for immediate communication with the customer as soon as they shop involving readily available media such as SMS, e-mail, instant messengers, mobile applications and the like.

Another object of the present invention is directed to a customer relationship and loyalty methodology and servicing system thereof whereby it would be possible to collect data from the Point of Sale in real time basis, such that the customer data is available in the MCRLP system as soon as the customer billing is completed.

Another object of the present invention is directed to a customer relationship and loyalty methodology and servicing system thereof whereby it would be possible to perform instant analytics at the billing terminal itself, thereby enabling customers to receive information, offers, vouchers, promotions and so on while they are still in the store. This also includes the systems, mechanisms and protocols to enable such scenarios.

Yet another object of the present invention Is directed to a mobile phone based mobile customer relationship and loyalty methodology and servicing system thereof which would be adapted also to handle possible change of mobile numbers and/or for occasions where the customer would not want to disclose his or her mobile number.

A further object of the present invention is directed to a mobile phone based mobile customer relationship and loyalty methodology and servicing system thereof which would be adapted to authenticate any user change in mobile number.

A further object of the present invention is directed to a mobile phone based mobile customer relationship and loyalty methodology and servicing system thereof which would enable maintenance of customer preferences of communication delivery instructions (such as unsubscriptions, and delivery rules) in a suitable fashion and follow regulatory requirements such as “Do Not Disturb” lists.

A further object of the present invention is directed to a mobile phone based mobile customer relationship and loyalty methodology and servicing system thereof which would be adapted to handle the redemption of points and vouchers even in case of no direct identification and no internet connection.

A further object of the present invention is directed to a mobile phone based mobile customer relationship and loyalty methodology and servicing system thereof which would enable a customer relationship and loyalty program that does not rely only on “points” or virtual currency for gratifying customers, but also on other dynamic mechanisms such as instant gratifications and milestones based vouchers that the customers can redeem in the stores.

A further object of the present invention is directed to a mobile phone based mobile customer relationship and loyalty methodology and servicing system thereof which would enable the campaign module to run in a fraud proof manner by giving out unique voucher codes for every voucher that goes out and validating them before usage both in connected and disconnected (to internet) settings.

Yet further object of the present invention is directed to a mobile phone based mobile customer relationship and loyalty methodology and servicing system thereof which would be adapted for running schemes such as incentivized referral programs.

Yet further object of the present invention is directed to a mobile phone based mobile customer relationship and loyalty methodology and servicing system thereof which would be adapted for integration with billing system such as involving screen scraping.

Yet another object of the present invention is a mechanism that lets the user identify their self to the customer relationship and loyalty methodology by making use of additional devices, or voice protocols such as calling a designated phone number which is connected to the system and acts as an input.

Another object of the present invention is directed to a mobile phone based mobile customer relationship and loyalty methodology and servicing system thereof which would further enable communication with user friendly gadgets such as information kiosk/web portal/mobile application and the like.

A further object of the present invention is directed to a mobile phone based mobile customer relationship and loyalty methodology and servicing system thereof which would enable integration and synchronization of working system during connected and disconnected mode.

### SUMMARY OF THE INVENTION

Thus according to the basic aspect of the present invention there is provided a mobile phone based mobile customer relationship and loyalty servicing system comprising:
(i) Mobile phones/like mobile operative devices of the end users/customers
(ii) At least one client component at the retail/sales outlets including computer means adapted for point of sale system and MCRLP client applications involving activations from said mobile phone/mobile operative devices of the end users
(iii) A server component comprising an MCRLP main server system adapted for operative connection to said one client component means at the retail/sales outlet for synchronization comprising:
   (a) Central Bookkeeping server containing the application logic
   (b) Communication Engines (for SMS/Email/Instant Messenger etc.)
   (c) Security and Validation code generation routines, to thereby provide for customer friendly customer relationship and loyalty servicing.
   (d) Reporting Engine adapted to make available the data being collected using MCRLP to the management in a simplified structure preferably also including a HyperCube functionality adapted to allow further drill up and drill down of data in a dynamic setting;

Another aspect of the present invention is directed to a mobile phone based mobile customer relationship and loyalty servicing system comprising operatively connecting to the main server of the ERP/Accounting System containing the following:
(a) Inventory Masters, with Inventory categorization and coding
(b) Bill information said client component at the retail/sales outlet and MCRLP main server being operatively connected through internet continuously or selectively, said continuous connection favouring continuous real time synchronization of the server system to the client component at the retail/sales outlets for on line customer relationship and loyalty servicing.

A further aspect, of the present invention is directed to said mobile phone based mobile customer relationship and loyalty servicing system, wherein the customer identification comprises registering each customer and generating a unique ID and mapping the customer phone number to this ID and using the unique ID as an internal identifier and capturing profile including but not limited to Name, Address, Date of Birth, Sex, Birthday, Anniversary and other important days of the year which is used to validate the user in case of mobile number change or voucher redemption in certain cases with or without extra validation involving a Government approved ID preferably selected from Driving License, Passport, and also including the ability to update the mobile numbers for the user as their numbers change.

A still further aspect of the present invention is directed to said mobile phone based mobile customer relationship and loyalty servicing system, wherein the mobile number of the customer comprises a unique identifier and the points are recorded against the customer record along with past transaction data, redemption details, vouchers issued or redeemed in the past including instant vouchers and the like and the end user can be searched up using either the mobile number, or name, email address and the like.

According to yet another aspect of the present invention is directed to a mobile phone based mobile customer relationship and loyalty servicing system wherein the data flows from the POS system to the CRM system in a real time basis at the point of sale; rather than in “batch” steps at regular intervals to enable instant communication, analytics and redemption.

A further aspect of the present invention is directed to said mobile phone based mobile customer relationship and loyalty servicing system wherein the mobile phone/GSM Modem is connected to means adapted to receive SMS or other requests including Web-interface/mobile applications/Email/Instant Message and so on for the following:
(a) Receive requests for points querying;
(b) Receive requests of unique voucher issue;

The interfaces allow various scenarios including (a) view past transaction history, and check points and redemption options (b) View a redemption catalog, and an online product catalog (c) Check outstanding vouchers, and discount coupons and (d) Participate in various campaigns that the organization may run from time to time.

Importantly, in said mobile phone based mobile customer relationship and loyalty servicing system according to the present invention wherein said client component comprises:
a. Integration Layer adapted to customize and integrate with the client using techniques such as API Integration and screen scraping;
b. Data Input UI adapted to enter data regarding customer registrations, profile updates, billing information, points redemption, voucher redemption and the like;
c. Voucher Validation for the clients to validate vouchers that have been issued to the customer;
d. Local Database and Cache adapted to cache central data so that its accessible easily in the local machine, and also stores all the transactions and registrations locally until they have been synchronized successfully;
e. Synchronization Manager adapted to collect all the unsynchronized data at the local machine and synchronizes it with the main server online preferably involving an extensible Markup Language (XML) based API;
f. Instant Analytics Engine adapted for instant analytics at the point of sale including a Rule Engine, and the rules that the Marketing team sets for instant analytics and executes them at the time of billing to achieve targeted offers in an instant fashion;

Further in said mobile phone based mobile customer relationship and loyalty servicing system wherein said server component may comprise:
i. Analytics Engine adapted to generate insights based on trends of activities;
ii. Campaigns Engine adapted to assimilate various campaigns and integrated with the rest of the MCRLP system or used separately;
iii. Rule Authoring Framework adapted for instant analytics to runs on the Client requiring the rules to be written in a particular format.

Yet another aspect of the present invention is directed to said mobile phone based mobile customer relationship and loyalty servicing system adapted for (i) immediate communication including enabling instant connect with the customer, higher interactivity and impulse purchase behaviour and (ii) instant analytics enabling real time capturing of data and its use to run instant analytics at the point of sale itself based on variables comprising of (a) Current Purchase, (b) Customer Demographics and Scores, (c) Environment Information, and (d) Inventory Information, said system said adapted to generate instant outcomes consisting of Vouchers and other actions that are communicated to the customer for instant redemption

Advantageously also in said mobile phone based mobile customer relationship and loyalty servicing system as of the present invention comprising code based validation of mobile numbers including voucher validation and security mechanism preferably the voucher code is generated such that the code can be validated even when the network is not reachable/connected and thus enabling redemption of points and vouchers in a secure fashion in both connected and disconnected states

A still further aspect of the present invention is directed to a mobile phone based mobile customer relationship and loyalty servicing system comprising of the Client component that integrates with the Point of Sale system at the billing terminal using either software API based integration requiring customizations of the Point of Sale software, or by scraping the data from the screen without any modifications to the Point of Sale system.

Further more, said mobile phone based mobile customer relationship and loyalty servicing system of the invention comprising means for providing customer preferences for receiving communications, provision of alternative forms of generosity, milestone based programs, and instant analytics and vouchering.

According to yet another aspect of the present invention is directed to said mobile phone based mobile customer relationship and loyalty servicing system wherein said means at the retail/sales outlets comprises selectively of additional hardware as follows:
i. Data Entry Machines at the retail/sales counter including communication instruments to receive calls from the user and identify them appropriately;
ii. Data Entry Machines may scan the mobile directly through near-field communication technology such as femtocells, or radio frequency tags that are pre-associated with the mobile numbers at the time of customer registration. Any device that can either identify the mobile (IMEI number, IMSI number) or a pre-associated tag for the mobile may be used.
iii. Data Entry Machines that contains means for generating and sending unique bar codes through SMS, and subsequently scanning them for entry into the system.

According to an important aspect of the present invention is directed to a method of mobile phone based mobile customer relationship and loyalty servicing involving the above described system of the present invention comprising:

A) Activation at the client component Involving the following steps:
j) The mobile number of the customer is entered by the cashier either manually, or through other automated means such as a PIN entering devices, an-incoming phone which can identify the caller or hardware appendages as may be used for data entry;
ii) carrying out data availability check;
iii) capturing the data into the MCRLP Client system through the integration means
iv) in the instance the customer who is the target of the current process, is marked “unsynchronized” in the local database, it means the said customer doesn't have a globally unique ID in the system, which then needs to be generated;
v) carrying out data validation step including voucher validation in case the process requires validation;
vi) in case the Client is in the disconnected state, the changes are cached in the local database, and uploaded whenever a sync is done (either on scheduled events, or manually);
vii) at this point any instant analytics can be run to generate dynamic vouchers for the user.

B) Activation at the Server component involving the following steps:
(i) validating the data from the MCRLP Client component, cleaning up, and then adding or updating in the database as required;
(ii) Any configuration defined by the client is respected, as the bills are stored for data-warehousing purpose, and points calculation is done, the functionality of the MCRLP Server is made very dynamic using the simple mechanisms including “Listeners” and “Trackers”.
(iii) Executing listeners with the relevant supplied data on the occurrence of any Event including Customer Registration, Billing, Voucher Issue, Voucher Redemptions, Customer Referral and the like
(iv) tracking the actions of a particular user and generate cumulative aggregates of various quantities for particular periods of time with or without integration with listeners Including extraction of data required to be to be tracked involving preferably templates for capturing this data from the information supplied to listeners; storing the thus extracted data in a separate structured location to facilitate aggregating and calculating the same preferably defining threshold values for cumulative aggregates, and subsequently performing certain actions on the threshold values being exceeded and finally enabling the same through “Listeners” defined above.

Another aspect of the present invention is directed to said method of mobile phone based mobile customer relationship and loyalty servicing comprising carrying out campaign functionalities and incentive referral programs in relation to the above stated steps.

The details of the invention, its objects and advantages are explained hereunder in greater detail in relation to non-limiting exemplary illustrations as per the following accompanying figures wherein:

### BRIEF DESCRIPTION OF THE ACCOMPANYING FIGURES

FIG. 1: is a schematic illustration of the system and methodology of the mobile phone based mobile customer relationship and loyalty methodology and servicing system thereof in accordance with the present invention;

FIG. 2: is a detailed illustration of the applications and required adaptability of the client end server system and the centralized server system which is operatively linked to multiple client end servers;

FIG. 3: is a sequential illustration of the manner of activation of the client end server system in the present invention;

FIG. 4: is a sequential illustration of the manner of activation of the centralized server system adapted to operatively link to the client end servers;

FIG. 5: is an illustration of the voucher validation and security mechanism in the mobile phone based mobile customer relationship and loyalty methodology and servicing system thereof in accordance with the present Invention; and

FIG. 6: is a schematic illustration of the voucher validation workflow in the system of the invention.

FIG. 7: is a schematic illustration of the components that compose the Instant analytics and vouchering engine

### DETAILED DESCRIPTION OF THE INVENTION WITH REFERENCE TO THE ACCOMPANYING FIGURES

Interaction Diagram of the MCRLP System

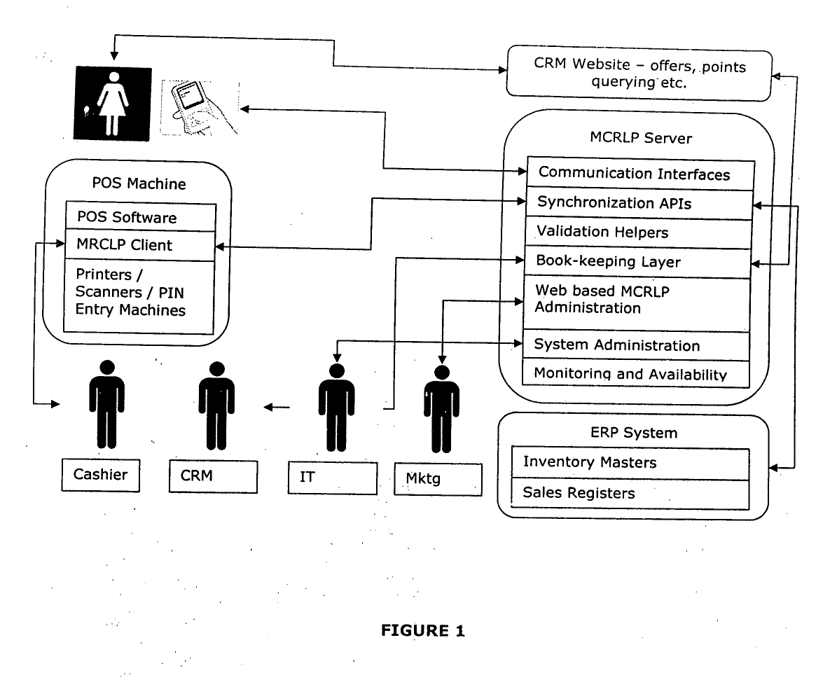

Reference is first invited to accompanying FIG. 1 which shows the system overview of the mobile phone based mobile customer relationship and loyalty methodology and servicing system thereof.

The system basically comprises of 2 parts: The Server component that does the data-warehousing and “points” book-keeping across all the terminals and the client component that is installed on the Casher's machine along with the POS software. This component integrates with the POS/ERP software and provides all the necessary user interface. This client supports two modes of operation—connected, when the network is available and the MCRLP server is reachable, and disconnected, when the server is not reachable. Connected mode is a simpler mode since the synchronization happens in real time and vouchers and validation etc. can be done far more smoothly. However, in the disconnected mode, a pre-defined protocol has to be defined so that the validations etc. can be done suitably. This client also includes instant analytics module that enables rules to be run to perform analytics. The architecture and system description followed is on the lines as already discussed hereinbefore.

The mobile number of the end customer acts as a unique identifier, and the points are recorded against the customer record along with past transaction data, redemption details, vouchers issued or redeemed in the past including instant vouchers and so on. The user can be searched up using either the mobile number, or name, email address and so on.

However, mobile numbers need to be properly validated since people know others'mobile numbers and there is no physical verification (unlike in cards). For this purpose, the invention proposes Code based validation that issues a unique code through SMS that is sent to that number, and can be validated against the customer. This is described in more details in the section titled “voucher validation and security mechanisms”.

At the same time, people often change their mobile phone numbers for various reasons, and hence the system requires a well-defined protocol for updating the mobile number with suitable security checks and validations. This protocol is described in more detail in the section.

In accordance with another aspect of the invention, the mobile phone based mobile customer relationship and loyalty servicing system is adapted for handling “Mobile Number Change” described in more detail in a subsequent section.

In some configurations, the MCRLP Server also contains an integrated Analytics and Campaigns Module that enables mining the data for insights and running targeted promotions using the same. The same is described in the section titled “Analytics and Campaigns”. It may also include a “Rule Authoring Framework” for instant analytics.

The entities that interact with the system are the following:
1. Cashier—The cashier who makes the bills or invoices using the Point of Sale software also tags the customer along with the same process in our system. Any unregistered users are registered therein. He may also use the system for redemption of points, updating customer data, and redeeming vouchers
2. I.T. Department of Organization—The I.T. department works on the maintenance, connectivity and smooth operations of the system. It also ensures that the inventory item masters (inventory item details along with attributes and values) are synchronized and any further data can be imported in the MCRLP Server
3. Marketing Department of Organization—The Marketing department formulates the schemes and coupons that are run as part of the system both in an instant and delayed communication scenario, as well as Analyze data and run campaigns.
4. End User—The end user communicates with the system by enrolling, and receives communications on his/her mobile phone. They also interact with the system using the web, or mobile media.

System Architecture of the MCRLP System

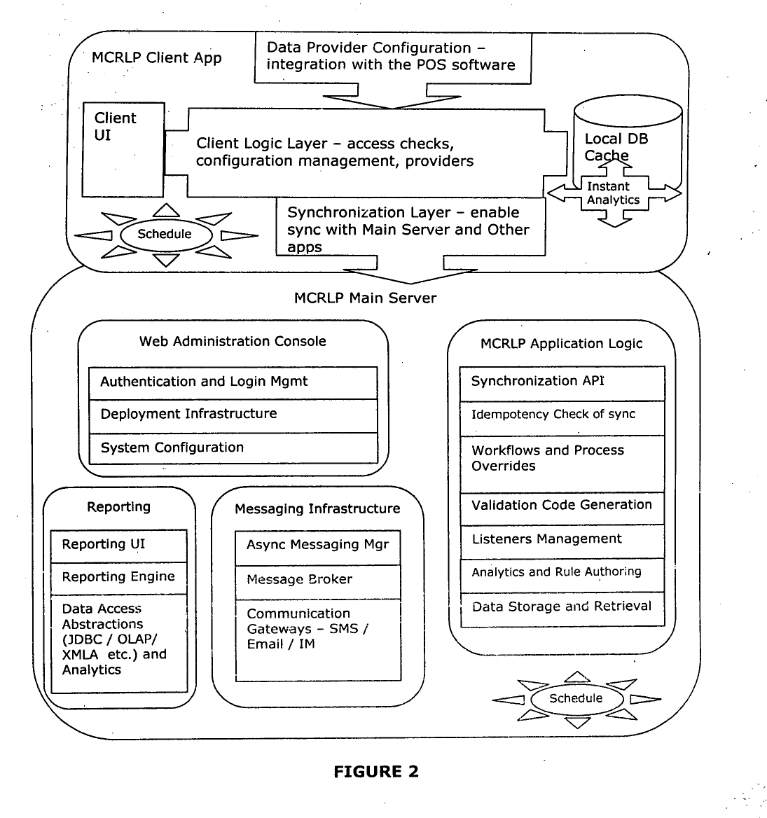

Reference is now invited to accompanying FIG. 2 which illustrates the system architecture of the mobile phone based mobile customer relationship and loyalty servicing system of the present invention.

As clearly illustrated in the FIG. 2 the main constituents are the Client Application, and the MCRLP Server. The main role of the Client Application is to interface with the POS Software and the Cashier to collect data, and the Server provides all the bookkeeping, communication management, validation management etc.

Client Component

As shown In said FIG. 2 the Client is adapted to provide a mechanism to integrate with the POS system, and the interface with the human cashier. It has the following main components:
1. Integration Layer—An integration layer to integrate with the client. This Integration needs to be customized for each organization Independently, and has to be plugged in appropriately. This is described in more detail in the section titled “Integration Mechanisms”
2. Configuration Manager—this downloads all the configuration defined on the server and stores it locally, enabling the Marketing Manager to configure all clients across all stores at a single point
3. Data Input UI—This UI lets the cashier enter data regarding customer registrations, profile updates, billing information, points redemption, voucher redemption and so on
4. Voucher Validation—This lets the client validate vouchers that have been issued to the customer
5. Local Database and Cache—This performs the following tasks—caches central data so that its accessible easily in the local machine, and also stores all the transactions and registrations locally until they have been synchronized successfully.
6. Synchronization Manager—This is the piece that takes all the unsynchronized data at the local machine and synchronizes it with the main server online. An extensible Markup Language (XML) based API is used for this purpose.
7. Instant Analytics Engine—This enables instant analytics at the point of sale. This includes a Rule Engine, and the rules that the Marketing team sets for instant analytics and executes them at the time of billing to achieve targeted offers in an instant fashion. The same is described in more detail in the section titled “Instant Analytics and Vouchering”
8. Timer-based integration components—Some stores might require data-export or import that can be done at regular intervals using a scheduled event executor.

Server Component

As also illustrated in the figure the server component acts as the single point of contact of all clients, does all the book-keeping, and manages synchronization across the clients. It has the following main components:
1. MCRLP Application Logic—This is the core of the MCRLP application, and provides all the business logic. From the data coming in through the API, to managing the data storage, issuance of voucher codes for validation, it manages all the operations. This is explained in more detail later.
2. Messaging Layer—This includes an interface with the SMS/Email Gateway and a single point of access to them. This includes relevant redundancy in case the messages fail to deliver.
3. Reporting Engine—The data being collected using MCRLP is made available to the management in a simplified structure by this infrastructure. In some manifestations, the reporting engine may also include a HyperCube functionality that allows further drill up and drill down of data in a dynamic setting.
4. Analytics Engine—The data can be analyzed to generate insights that might be beneficial to the business. The same may be integrated into the system in many manifestations
5. Campaigns Engine—The insights above and other campaigns can be run through a Campaigns Engine, which may be integrated with the rest of the MCRLP system or used separately.
6. Rule Authoring Framework—The instant analytics that runs on the Client requires the rules to be written in a particular format. The same is activated using a Rule Authoring framework that is present at the server end. This is described in more details in the “Instant Analytics and Vouchering” section.

Customer Identification

In accordance with a further aspect of the invention the mobile phone based mobile customer relationship and loyalty servicing system is adapted to serve as identifier generation and profile capturing purposes as further explained hereunder:

Every customer has to be registered in the system and a unique ID is issued against the said customer. This unique identifier is Internal to the system and never communicated to the user, and the phone number is mapped to this unique ID. The rest of the infrastructure refers to this ID. Maintaining an internal Identifier for an entity is usually the norm in all software systems, however, in this case it's more important than usual since the mobile number is prone to changing.

Along with the identifier generation, the relevant customer profile is also captured including but not limited to Name, Address, Date of Birth, Sex, Birthday, Anniversary and other important days of the year. This information is also used to validate the user in case of mobile number change or voucher redemption in certain cases. These profile details when used individually, or along with extra validation using a Government approved ID such as Driving License, Passport etc. are termed as external identifiers in subsequent exposition.

Integration Mechanisms

The Integration Mechanisms Followed by the System of the Invention Involves the Following:

For an effective and usable system integration with existing IT infrastructure such as Enterprise Resource Planning (ERP) or Point of Sale (POS) is vital. For this purpose, the MCRLP system allows integration with the external system with well defined interfaces (which are not described here for lack of space), and enable the customer to plug in a customized integration solution which implement well defined interfaces.

Also, for the purpose of integration with legacy systems or cases where the support of the existing POS vendor is not available, a mechanism has been developed to pick out the data in the system through screen scraping. This mechanism employs the Windows API to make the window re-draw its contents and intercepting the data that is sent to the video layer. This data is then extracted as text and parsed in the required format. All the transformations that need to be done are declaratively given in a suitable configuration file, and primarily use regular expressions for the purpose of parsing the relevant text out. The declarations contain the window identifier from which the text Is to be picked (using the Window class, and the caption), and also a set of regular expression to take out the relevant information in structural format from the captured text. In some manifestations, basic integration may be provided with the POS software so that the triggering of the MCRLP Client application after the creation of a bill is automated.

The Other Customer Interfaces in the Present System of the Invention Involves the Following:

The data being collected by the MCRLP system has to be made accessible to the customer through various mechanisms, most notably, through a customer portal where the customer can login and check details. This portal is hosted along with the MCRLP Server, and can display the valid data through direct database or API interaction. Some features of this portal are:
1. Ability to login and view and update profile information
2. View past transaction history, and check points and redemption options
3. View a redemption catalog, and an online product catalog
4. Check outstanding vouchers, and discount coupons
5. Participate in various campaigns that the organization may run from time to time

One notable point here is that the customer doesn't need to keep a login and password. When the customer wants to login, a validation code is generated and sent to the customer, which is valid for a few hours. This can be used to login and access the details.

The same may be available through a mobile application as well, which is accessible over smartphones using APIs (including but not limited to iPhone, Android, Windows Phones, Blackberry, and Java based devices), a WAP portal and SMS.

Immediate Communication

The system is designed In such a way that as soon as the MCRLP Client uploads the data to the MCRLP server, the server activates all necessary calculations and communications right away. This enables an instant connect with the customer, higher interactivity, and impulse purchase behaviour

Reporting

The system is designed to integrate various reporting services within its framework to make the data available to the Retail client in a meaningful format. This includes various reports that expose the data being captured, including but not limited to:
1. Customer information and lists, along with reports on their preferences, demographics, purchase patterns and so on
2. Billing patterns of different stores with emphasis on customer data, along with store comparisons based on customer loyalty
3. Inventory level reports—inventory affinity of customer clusters, preferences, and so on
4. Campaign response reports and return on Investment reports on a real time basis

These reports can be customized for different Retail Clients as per their preferences. They are usually a standard component.

In the current object of the MCRLP system, the big differentiator is that since the data is being collected in a real-time basis—that enables these reports to be generated in real time as soon as the data is captured at the Point of Sale system and communicated back to the central system.

Analytics

As described in the Background Art, analytics is once again a standard component of many CRM systems. This includes techniques to cluster users, stores, inventory items; classify users based on their propensity for respond to certain kinds of campaigns and affinity for certain inventory items and categories; develop product relationships and associations based on the data. The same can be included as part of an MCRLP system in either an integrated fashion or as a separate system that reads data from the MCRLP system and uses it to run campaigns.

However, since the MCRLP system enables real-time capturing of data, the same can be used to run instant analytics at the Point of Sale itself, and the mechanisms for the same is described in more details in the section titled “Instant Analytics and Vouchering”

Operational and Activation Procedures for MCRLP System

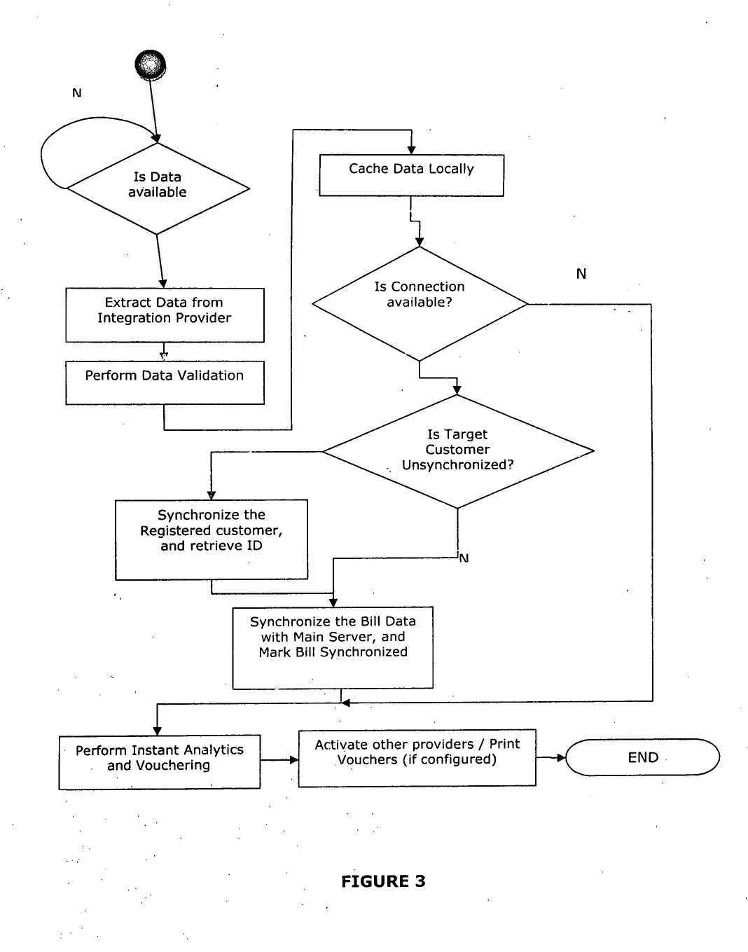

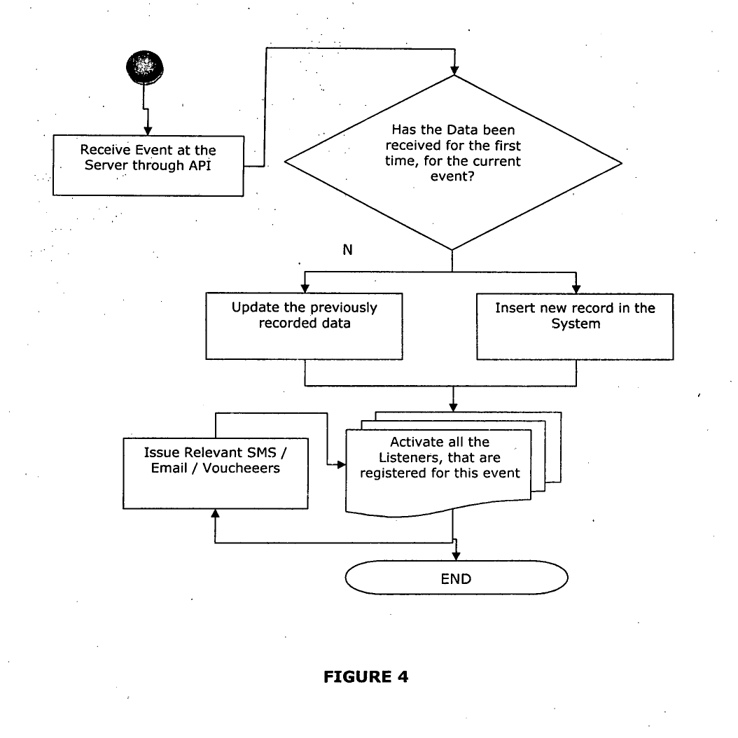

Operational and Activation Procedures for mobile phone based mobile customer relationship and loyalty servicing system of the invention are further discussed hereunder in relation to accompanying FIGS. 3 and 4 wherein FIG. 3 shows the activation procedure for the MCRLP Client while FIG. 4 shows the activation procedure for the centralized (main) server.

Activation Procedure for the MCRLP Client

The main pathway for activation leads from data generation at the end of the POS, to its distribution across all the other stores. This follows the following steps:
1. The activation protocol adopted at the client end is described clearly in FIG. 3. Some salient features about this are: The mobile number of the customer is entered by the cashier either manually, or through other automated means such as a PIN entering devices, an incoming phone which can identify the caller or hardware appendages as may be used for data entry. Such hardware appendages are described in more detail in the section titled “Data Entry Machines”
2. The data availability check can be made by the triggering of an event (such as Key press, or presence of a file in a particular directory, or call of an API function)
3. The data is then captured into the MCRLP Client system through the integration means described in the subsection titled “Integration Mechanisms”
4. If the customer who is the target of the current process, is marked “unsynchronized” in the local database, it means the said customer doesn't have a globally unique ID in the system, and it has to be generated
5. The Data Validation Step also includes voucher validation in case the process requires validation—this is blown up and explained later in the exposition in more detail
6. In case the Client is in the disconnected state, the changes are cached in the local database, and uploaded whenever a sync is done (either on scheduled events, or manually).
7. At this point any instant analytics can be run to generate dynamic vouchers for the user. The same is described in more detail in the section titled “Instant Analytics and Vouchering”

Activation Procedure for the MCRLP Server

The activation protocol followed in the centralized (main) server is clearly illustrated in accompanying FIG. 4. As the data comes In from the MCRLP Client, first it is validated, cleaned up, and then added or updated in the database as required. Any configuration defined by the client (such as “Allow Duplicate Bills Numbers only when they are from different stores”, “Allow Duplicate Bill numbers from the store as well” and others) that depend on the architecture of the Client ERP/Billing HO system are respected. As the bills are stored for data-warehousing purpose, and points calculation Is done, the functionality of the MCRLP Server is made very dynamic using the simple mechanisms described below called “Listeners” and “Trackers”.

Listeners

Different retail clients of the MCRLP system would want different actions to be performed in the case of every event. The list of actions may include but not be limited by the following:
1. Send an SMS with a particular text
2. Send an Email with a particular Text
3. Send a Campaign Voucher from a particular campaign
4. Update the customer details—such as their “Slab”
5. Send a voucher from another organization—“Cross-Promotion”
6. Do the above based on some conditions
7. Inform the management about the transpiring of a particular event.

In the current manifestation of the MCRLP system (not a necessary requirement for any other MCRLP system), Listeners are executed with the relevant supplied data on the occurrence of any Event (such as Customer Registration, Billing, Voucher Issue, Voucher Redemptions, Customer Referral and so on). The same can be configured using a web based UI.

Trackers

In certain cases, functionality is required to be able to track the actions of a particular user and generate cumulative aggregates of various quantities for particular periods of time. In case of certain conditions being met, some of the actions listed above in the “Listeners” subsection may be performed (eg., slab upgrade, voucher issue etc.).

The MCRLP system can define extraction mechanisms that can extract the data that is needed to be tracked. This may include information from bills, inventory items the customer has purchased based on certain attributes, campaign response information and so on, and may include complex scenarios such as:
1. Track customer purchases of premium blue shirts over a 6 month period
2. Track number of campaigns the customer has responded to in a 1 year period
3. Track number of visits in which the customer has bought more than Rs. 1000
4. Track cumulative amount of milk the customer has purchased in the last 1 month and get average milk consumption.

These quantities can be extracted by defining templates for capturing this data from the information supplied to listeners.

As these quantities are extracted and stored in a separate structured location, aggregates can be calculated for the same (sum, average, standard deviation etc.). Threshold values can be defined for these cumulative aggregates, and certain actions can be performed on the threshold values being exceeded. The same is enabled through “Listeners” defined above.

Campaigns Functionality

Any good CRM system provides functionality to run campaigns for customers. However, the level of integration with the rest of the CRM system may vary. In the current invention, the Campaigns functionality is tightly integrated into the MCRLP system to provide the ability to run campaigns in a simple yet effective fashion. The integrated campaigns engine provides the ability to select subsets of the customer database based on multiple filters and target communication to them. The communication is sent to the target customers through the integrated or external gateways (Email, SMS, IM, Direct Mailers and so on).

An important factor in running campaigns is to run them in “fraud-proof” fashion. In the manifestation of the MCRLP system that we are presenting, there is capability to send the campaign messages with a unique voucher-code (a unique combination of alphanumeric characters) in a way such that before providing the benefit of the campaign the voucher is validated to ensure that it is valid and meant for the user who is trying to redeem it. The same is based on various configuration options provided at the time of creating the campaign, some examples being. “Can the user redeem it more than once?”, “Can more than one user redeem it?”, “Can any user redeem it or only the user to which it was issued?”, “Maximum number of vouchers that can be issued”, “Maximum number of vouchers that can be redeemed (early bird)”. At the time of redeeming the campaign, the necessary checks are made before the voucher redemption goes through. This prevents fraud by the cashier who is creating the bill—because the cashier would not have access to the Voucher code and hence can not distribute the campaign benefit to a subject without the necessary checks.

In order to maintain this system reliability and operations even In the scenario when there is no Internet connection (disconnected mode) for short duration of times, there's the ability to do the validation directly from the server. This is described in more details in the subsection titled “Disconnected Functionality”. Once the voucher is validated, the regular operation continues.

Incentivized Referral Programs

With respect to another aspect of the current invention, the Retail Clients are provided with an option to run an incentivized referral program. The referral program uses the customers as advocates for inviting new customers. The program Is implemented in the following two ways:
1. As soon as the customer shops in the store, they are asked for the contact details of their friends who might be interested in the product. A Voucher code is sent to the friend (through SMS, Email, Mobile application etc.) containing some generosity that the friend can redeem by visiting the store. In case of the voucher code being used by the “friend” the original customer is given another voucher containing some other benefit. In alternative configurations, the vouchers can be given to the original customers based on more complicated parameters (such as more than x friends referred, or their cumulative purchases after shopping exceeds a certain amount)—this is enabled using the Listeners/Trackers functionality.
2. The customer is sent a communication with a unique voucher code valid for himself/herself that they can now forward to friends. As the friends use it, the same logic as in point (1) above is followed.
The incentivized referral program is a unique offering that enables intelligent use of mobile phones and an MCRLP system to invite new users. The whole system is managed automatically without any need for manual data collation.

Disconnected Functionality

The MCRLP System is designed to work both on online (connected) as well as offline (disconnected) mode. For this purpose, the MCRLP Client includes a local database on which the data is cached. In case when the terminal is online, the data is immediately synchronized to the MCRLP Server. When the terminal is offline, the data is cached, and marked as “unsynchronized” and is synchronized when the system comes up online.

A special mention is required of the case when points are to be redeemed or a campaign voucher has to be redeemed in the offline mode. In this case, the customer is required to send an SMS to a particular number in a pre-defined format. For points redemption, this SMS would include the organizational identifier and the points to be redeemed. For voucher redemption, this SMS would include the organizational identifier with the voucher code that needs to be redeemed. The server does the necessary verification at its end in the same manner it would do in the connected mode, and replies with a Validation code. At the same time, the server does the necessary redemption with the partial data until It receives the full data from the MCRLP client so that there is not possibility of the same voucher/points being misused at another location and another MCRLP client. The Validation code is generated in an algorithmic fashion that enables secure validation—and this mechanism is described in more details in the “Voucher Validation and Security Mechanisms” section under the “Voucher Code Generation” subsection later. Only upon the entry of the correct Validation code can the MCRLP Client can successfully perform the redemption and in any other case it throws up an error. In case the points can not be redeemed, or the voucher is not valid, the server responds with the necessary error message (eg., “Voucher Expired”, “Voucher Not meant for this user”, “Not enough points”) directly to the User's mobile device over SMS. Once the connection is re-established, information about the redemption is communicated to the MCRLP server.

A further point here is the SMS based communication is illustrative, and the same could have been performed using a web based model or a mobile application as described in the objects.

Mobile Number Change

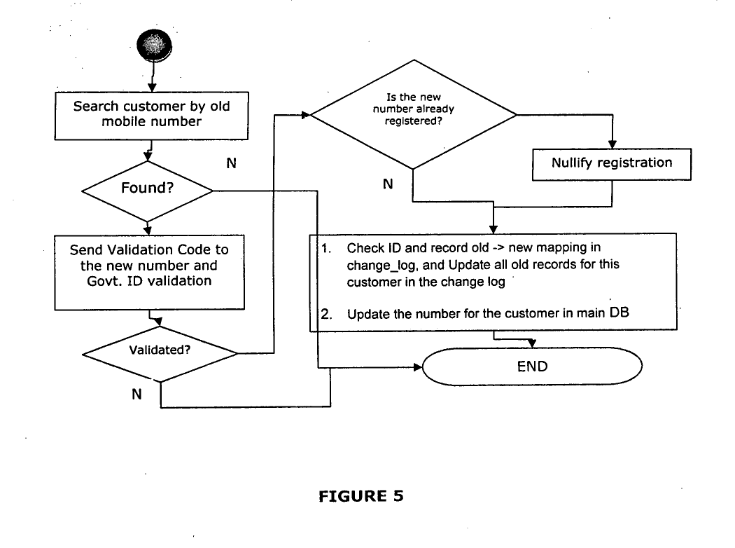

In accordance with another aspect of the invention, the mobile phone based mobile customer relationship and loyalty servicing system is adapted for handling Mobile Number Change as further discussed hereunder in relation to accompanying FIG. 5:

Since the mobile number is used as a unique identifier for the customer, and it is not uncommon to change mobile numbers, changes to the mobile number have to be handled carefully and seamlessly in order to ensure that the user is not inconvenienced due to this matter at all. Besides, it also needs necessary security check to ensure that a wrong person can't misuse somebody else's points. For this purpose external identifiers which had been recorded at the time of registration are cross verified.

The mapping of old number to new number has to be maintained in the system in case the process has to be cross verified.

Another issue to be kept in mind is that the new mobile number might already be registered in the system in the same or another customer (the previous owner of that mobile number) and the number stored against that customer has to be nullified, since that customer no longer owns that mobile.

Customer Preferences for Receiving Communication

To satisfy an aspect of the invention, the MCRLP system includes a mechanism for the customers to provide their preferences for receiving communications. This can include, but not limited to, the following:
1. Not receive “Campaign” or “Promotional” messages
2. Receive messages only during certain time periods
3. Black-out periods on which messages are not to be sent, etc.

The MCRLP System may include an interface where the customer can provide their preferences. This can be part of a web interface that is exposed to the customer, or through a mobile application, or simply through SMS. The customer can also provide the preferences at the Point of Sale terminal where they are directly entered in the MCRLP Client. These preferences may also be provided in a central database maintained by a trusted third party containing do not disturb lists, such as the “National Do Not Disturb Registry” in India which is available to marketers.

These preferences are respected while sending out the communications. Before sending out any communication its message class Is checked (eg., Transactional, Promotional) as well as the medium (Email, SMS, IM) and the communications are scheduled accordingly.

Alternative Forms of Generosity

The current MCRLP system also differs from traditional systems in its handling of customer generosity. In traditional systems, this has primarily been done with the concept of “points” or virtual currency that is issued to the customer. The same has been described in more details in the section titled “Background Art”.

In the current MCRLP system, other mechanisms for providing generosity have been provided. In some manifestation of the system, the standard “points” based system may be used. In other manifestations, the system may be used only as a data collection and collation system, and all generosity may be given in the form of vouchers that are issued to the customers at regular intervals based on their past purchase behavior and based on the organizational goals.

In yet other manifestations, a “milestone-based mechanism” may be used. This is described in more details hereunder. As described in the subsection titled “Trackers” customer behavior across multiple attributes may be tracked. The system may be configured to issue vouchers as customers cross certain milestones at regular intervals. Such milestones may have two components:

The primary generosities in this case is given out in the forms of vouchers as quantity tracked for every customers cross certain milestones. Eg., cumulative purchases, total number of items purchased, total value of “premium” products purchased and so on. As described in the “Trackers” section, as the value of the tracked quantity becomes more than a certain threshold value, generosity can be given to the customers automatically. Also, based on configuration, the tracker may be reset so that the tracking can start afresh. Some examples of such generosity may be “A free gift on every INR 5000 purchase”, “A Voucher for 20% off on the next purchase of above INR 1000 if you cross a cumulative purchase of INR 10000”, “Buy two items, get one free in your next purchase if a customer buys more than 3 trousers above INR 1500”.

In some configurations of the “milestone based generosity system”, these milestones may be structured in increasing order so that the customer gets higher generosity as they cross bigger milestones.

Instant Analytics and Vouchering

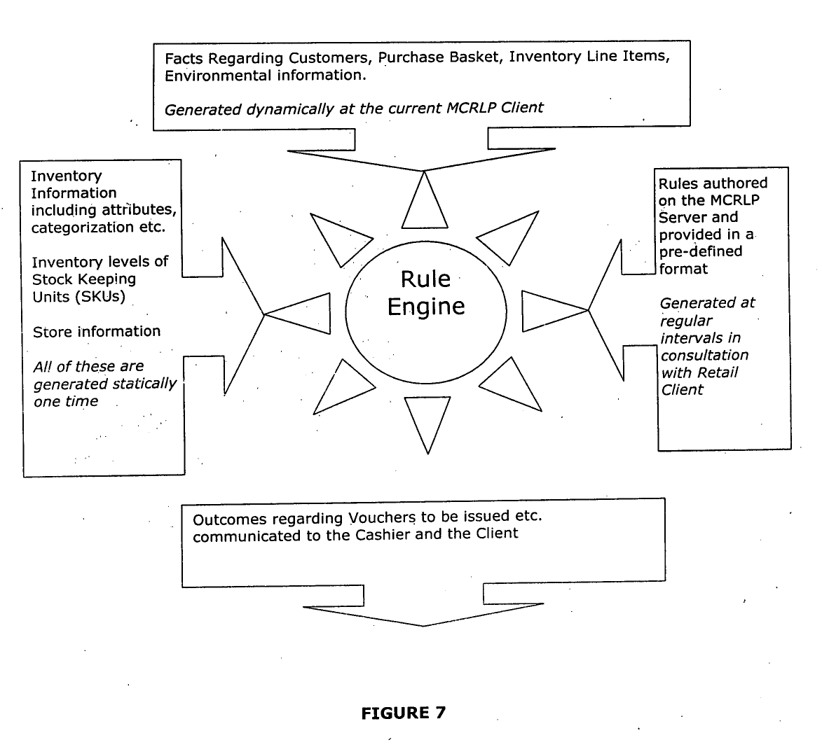

An important component of the current invention is the ability to do instant analytics. This is enabled by the real-time data collection at the Point of Sale. As a result of the instant real-time analytics, customers can receive immediate communication of very targeted offers based on information available at the cash till. This information or “factors” are encoded in the form of facts and are run through pre-defined rules to generate the set of outcomes. All these are enabled in a rule engine that is able to compute a large number of rules, take decisions in a quick format, and convert these decisions into outcomes that are communicated to the customer. Each of these components are described in more detail below and an exposition of the exact workflow follows. Reference is brought to FIG. 7 for the following exposition which gives the components that go into the Instant Analytics.

Factors: Various points of information are encoded in the form of facts. These facts encode specific bits of information in a canonical template and mathematically comprehensible format. Some of these factors are:
1. Current Purchase Basket—This encodes the information about the current purchase the customer has made, and includes details like the Bill Number, the Amount of the Bill, the discounts already claimed, the inventory items along with the quantities, rates, values of each, as well as attributes of every item purchased. This requires the
2. Customer Demographics and Scores—The customer information is also encoded and provided to the Instant Analytics engine, this may include factors such as their age, their birthdate, marital status, location, the last visit date, city, zip code and so on. Apart from that, some bits of information may be pre-computed about the customers and is also encoded. Such information may contain things like affinity for premium products, the number of items they are most likely to purchase, and so on.
3. Environment Information—This encodes information relevant to the particular store/cash till where the MCRLP client is running and may includes factors such as location information (city of the store, PIN/ZIP code, region), whether it is in a mall or high street, if there are any festivals forthcoming in the local geography and so on. Also information such as the time of the day, whether it's a weekday or a weekend is also encoded.
4. Inventory Information—This may include information such as what are the inventory information at the store, velocity of individual inventory items and the ones that need to be pushed out and so on.

Each of them are encoded using a Fact “class”—eg., StoreInformation, InventoryItemInformation and so on. There are other fact classes to store the outcome—eg., “VoucherToBeIssued”, “PointsToBeAdded”

Before the invocation of the Rule Engine such information is encoded correctly and is apprised to the rule engine in the correct format.

Rules: The other important criteria is the actual rules that take the decisions. These rules are authored in an authoring framework (which may reside along with the MCRLP Server in most manifestations). The rules are designed in consultation with the market team of the Retail client on the basis of their marketing goals and follow the grammar below:
Rule: Rule_name Attributes when Condition then Outcome end
Rule_name: String
Attributes: A list of <Attribute_Name, Attribute_Value> pairs
Condition: Mathematical expression encoding facts defined above that results in a Boolean output. If the condition is satisfied then the rule is executed
Outcome: If the rule is satisfied, the outcome is asserted. This outcome is defined in the form of a new Fact of the outcome class that gets asserted.

The rules are made available to the rule engine in a text or binary format at the MCRLP Client. These rules are updated on a regular basis as per the requirements of the Retail client and provided to the MCRLP Client through the MCRLP Server.

The “Rule Engine” is s standard piece of mathematical tool that can take the rules (suitably modeled) and the facts (suitably modeled) and generate the correct outcomes. These rule engines are well-engineered to run the rules at scale and compute thousands of rules and millions of facts. The rule engine may be provided either as a module (library) or as a separate service.

Outcomes: The outcomes after the computation of the rule engine need to be converted into a visible outcome for the customer. Some of these could, for instance, be:
1. Issue a Voucher to the customer—The voucher type and other details are extracted from the. Outcome template and the correct voucher should be issued to the customer and messaged to him/her with a suitable message.
2. Increase Points of the customer—similar to the above, the right action is taken and communicated to the customer

Other types of Outcomes may be added as per the requirements of the retail client. Also, the outcome may be displayed to the Cashier making the bill in some configurations.

A note, must be made of the fact, that while the “Rule Engine” as a raw technology is available in prior art, its application in the workflow defined above is unique.

Voucher Validation and Security Mechanisms

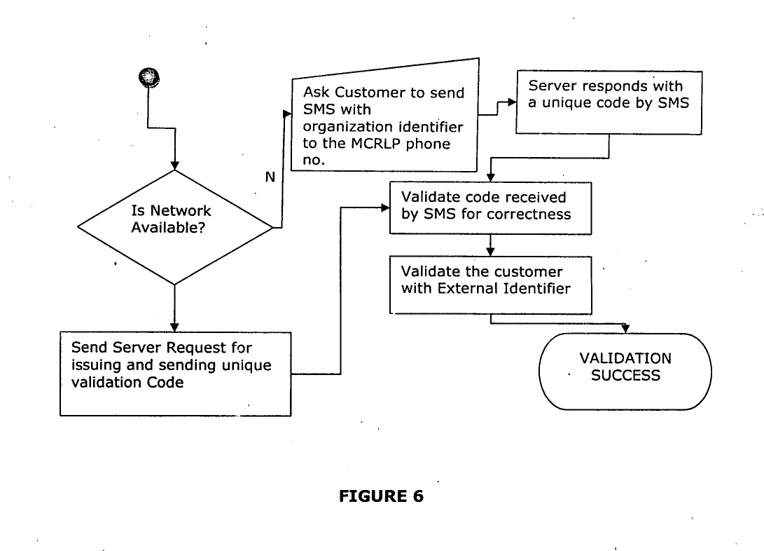

In accordance with yet another aspect of the invention, the mobile phone based mobile customer relationship and loyalty servicing system is also adapted for voucher validation and security mechanisms as discussed hereunder in relation to accompanying FIG. 6:

This is one of two procedures that form are unique in the mobile scenario. The aim Is to validate that the identity of the customer as the owner of the mobile phone, whether the network Is accessible on the Cashier Point of Sale or not.

Voucher Code Generation

The voucher code has to be generated In such a fashion that the code can be validated even when the network is not reachable, and the server can't inform the client what codes have been issued. Some other requirements from the code are:
1. Should use only alphanumerics (0-9 and A-Z) to ensure ease of reading (case insensitive)
2. Encode all the relevant information to validate the right customer with the code
3. Allow validation in disconnected mode as well
4. The code should be able to be translated into a barcode-compatible representation easily, and this should be optional since may devices may not be able to show barcodes
5. There shouldn't be any requirement for pre-assigning codes at the client end, in case the Client is unable to synchronize for a long period of time
6. The Voucher code should get invalidated if not used within a certain amount of time
7. (Optional) A voucher issued for a particular store should be valid only in that store.

Keeping in mind the above requirements, as a non-limiting exemplary illustration the following scheme has been developed. The alphanumeric requirement is met by encoding it in Base 36 that allows for alphanumeric representation. The information that needs to be encoded is given below and a recommended encoding is given in the table below:

| Information | Size | Notes |
|---|---|---|
| Organization Code | 24 Bits | Uniquely identify the |
| | | organization |
| Customer Code | 24 Bits | Uniquely identify the mobile |
| | | number to be validated |
| Purpose (Registration/ | 3 Bits | Define the purpose of |
| Redemption/Mobile Change) | | validation |
| Issue_Time (seconds from | 13 Bits | The time is used to ensure |
| the beginning of the month) | | that the voucher can be |
| | | used only for a specified |
| | | time. Its broken down into |
| | | 2 parts as described |
| Total | 32 Bits | |

Optionally this could further include the store ID for meeting the requirement (8) above. The voucher code is issued using a combination of the fields described above, so that it generates a unique code that is unique to the particular organization, purpose, mobile number, and only valid for a short period of time. The current time period is broken down into two parts—a fixed part and a variable part. The voucher code generation works by using bitwise operations such as AND, OR, XOR and cryptographic hash functions to generate a voucher code that will be unique. One sample function could be:
f₁=h₁(org_id, purpose, fixed_time_component)
f₂=h₂(mobile)
f₃=h₃(variable₋time_component)
f=f₁̂f₂̂f₃
   where, f denotes the codes at various stages of computation, and h are one-way hash functions (such as MD5, SHA-1). ̂ denotes bitwise XOR.

In this scheme, at the time of validation, f₁ and f₂ should be identical as computed on the server, and hence the final f value can be computed by substituting values of the variable time suitably (the current time, or a few past time-identifiers to accommodate for delays).

The f computed above is further encrypted using standard encryption technologies so that an outside party can't regenerate the values.

It may be noted that while computing the hash values, the actual calculated values are usually longer (about 128 bits), and hence, a suitable mechanism may be used to map it to a smaller number of bits (either stripping the left-most bits, or XOR'ing them together).

All this information is encrypted using Private Key encryption. On receiving the voucher code, the MCRLP client validates the Customer Code against the mobile number, and the organization code against the company. It also verifies the purpose and the issue time to make sure that the voucher is still valid. It then marks the voucher invalid so that it can't be used again.

The actual manifestation of the code may vary based on implementation. However, the core idea is to generate one-way hash suitably encoded by using some secure means that can be independently validated.

Security Issues and Addressal

Some illustrative options:
1. The user not being the owner of the mobile phone—validated by sending a unique code to the user. This is a simple pathway in the Connected mode, but in Disconnected mode, there is no way of sending an SMS to the user, so the customer is asked to send an SMS to validate himself/herself to a particular number
2. In the disconnected mode, a fraudulent customer may have access to a mechanism to send SMS impersonating as somebody else. This is dealt with by sending a unique code to the customer even though the system can validate by incoming SMS. This establishes authenticity since the SMS sent from our server would only be delivered to the said mobile number
3. The user managing to get access to somebody else's phone—this is validated by profile details filled at the time of registration. Asking questions about the external identifiers as defined in previous sections.

Optional Hardware Components

Additional hardware may be added to address some of the concerns. Some of these concerns are:
1. Higher data entry throughput at the Cashier terminal—Typically, in most stores, the line for billing is very long and there is a need to keep the data entry time shortest. Manual entry of Coupons etc. may slow down the process
2. Customer not willing to share their mobile number with the Retailer—In case the customer doesn't want to share their mobile number with the retailer, the system has to be designed to let the customer identify himself/herself through another mechanism.

In accordance with yet further aspects of the invention the mobile phone based mobile customer relationship and loyalty servicing system of the invention can be adapted for the following additional servicing provisions:

Barcoded Coupons

The coupons are encoded as an image and sent to the phone as a picture message, or MMS, or by email (for smartphones with email access). This enables, the cashier to scan the barcode using a standard barcode scanner.

The main challenge is converting the image generated from the barcode into a form that can be consumed, by a mobile handset and delivered through SMS.

Optionally this includes the store ID for the requirement (8) above.

Data Entry Machines

A machine for entering the mobile number is provided at the terminal that lets the user enter the mobile number without the cashier getting access to it. This machine is similar to the PIN entry machines seen for debit card transactions. The number directly goes to the MCRLP system without the cashier getting access to it.

In some configurations, the Data Entry Machines may scan the mobile directly. This may be through near-field communication technology such as femtocells, or radio frequency tags that are pre-associated with the mobile numbers at the time of customer registration. Any device that can either identify the mobile (IMEI number, IMSI number) or a pre-associated tag for the mobile may be used.

Telephonic Data Entry

In yet another manifestation of the invention, a telephone or similar device may be attached to the billing counter, where the user can call up and easily identify himself/herself. The customer is identified by making use of the caller ID feature of new mobile phones. This can make the billing process far quicker.

It is thus possible by way of the present invention to provide for a customer friendly and reliable mobile phone based mobile customer relationship and loyalty methodology and servicing system thereof which would enable the customer to activate the services offered at the retailers outset and the like as soon as they shop using their mobile phones involving media such as SMS, e-mail, instant messenger etc. and thereby favour a more customer friendly customer relationship and loyalty servicing.

1. A mobile phone based mobile customer relationship and loyalty servicing system comprising:
(i) Mobile phones/like mobile operative devices of the end users/customers
(ii) At least one client component at the retail/sales outlets including computer means adapted for point of sale system and MCRLP client applications involving activations from said mobile phone/mobile operative devices of the end users
(iii) A server component comprising an MCRLP main server system adapted for operative connection to said one client component means at the retail/sales outlet for synchronization comprising:
(a) Central Bookkeeping server containing the application logic
(b) Communication Engines (for SMS/Email/Instant Messenger etc.)
(c) Security and Validation code generation routines, to thereby provide for customer friendly customer relationship and loyalty servicing.
(d) Reporting Engine adapted to make available the data being collected using MCRLP to the management in a simplified structure preferably also including a HyperCube functionality adapted to allow further drill up and drill down of data in a dynamic setting.

2. A mobile phone based mobile customer relationship and loyalty servicing system according to claim 1 comprising:
(i) Mobile phones/like mobile operative devices of the end users/customers
(ii) At least one client component at the retail/sales outlets including computer means adapted for point of sale system and MCRLP client applications involving activations from said mobile phone/mobile operative devices of the end users
(iii) A server component comprising an MCRLP main server system adapted for operative connection to said one client component means at the retail/sales outlet for synchronization comprising:
(a) Central Bookkeeping server containing the application logic
(b) Communication Engines (for SMS/Email/Instant Messenger etc.)
(c) Security and Validation code generation routines, to thereby provide for customer friendly customer relationship and loyalty servicing.
(d) Reporting Engine adapted to make available the data being collected using MCRLP to the management in a simplified structure preferably also including a HyperCube functionality adapted to allow further drill up and drill down of data in a dynamic setting,
which is operatively connected to the main server of the ERP/Accounting System containing the following:
(a) Inventory Masters, with Inventory categorization and coding
(b) Bill information
said client component at the retail/sales outlet and MCRLP main server being operatively connected through internet continuously or selectively, said continuous connection favouring continuous real time synchronization of the server system to the client component at the retail/sales outlets for on line customer relationship and loyalty servicing.

3. A mobile phone based mobile customer relationship and loyalty servicing system as claimed in claim 1, wherein the customer identification comprises registering each customer and generating a unique ID and mapping the customer phone number to this ID and using the unique ID as an internal identifier and capturing profile including but not limited to Name, Address, Date of Birth, Sex, Birthday, Anniversary and other important days of the year which is used to validate the user in case of mobile number change or voucher redemption in certain cases with or without extra validation involving a Government approved ID preferably selected from Driving License, Passport, and also including the ability to update the mobile numbers for the user as their numbers change.

4. A mobile phone based mobile customer relationship and loyalty servicing system as claimed in claim 1, wherein the mobile number of the customer comprises said unique identifier and the points are recorded against the customer record along with past transaction data, redemption details, vouchers issued or redeemed in the past including instant vouchers and the like and the end user can be searched up using either the mobile number, or name, email address and the like.

5. A mobile phone based mobile customer relationship and loyalty servicing system as claimed in claim 1 wherein the data flows from the POS system to the CRM system in a real time basis at the point of sale; rather than in “batch” steps at regular intervals to enable instant communication, analytics and redemption.

6. A mobile phone based mobile customer relationship and loyalty servicing system as claimed in claim 1 wherein the mobile phone/GSM Modem is connected to means adapted to receive SMS or other requests including Web-interface/mobile applications/Email/Instant Message and so on for the following:
(a) Receive requests for points querying
(b) Receive requests of unique voucher issue
the interfaces allow various scenarios including (a) view past transaction history, and check points and redemption options (b) View a redemption catalog, and an online product catalog (c) Check outstanding vouchers, and discount coupons and (d) Participate in various campaigns that the organization may run from time to time.

7. A mobile phone based mobile customer relationship and loyalty servicing system as claimed in claim 1 wherein said client component comprises:
a. Integration Layer adapted to customize and integrate with the client using techniques such as API Integration and screen scraping;
b. Data Input UI adapted to enter data regarding customer registrations, profile updates, billing information, points redemption, voucher redemption and the like;
c. Voucher Validation for the clients to validate vouchers that have been issued to the customer;
d. Local Database and Cache adapted to cache central data so that its accessible easily in the local machine, and also stores all the transactions and registrations locally until they have been synchronized successfully;
e. Synchronization Manager adapted to collect all the unsynchronized data at the local machine and synchronizes it with the main server online preferably involving an extensible Markup Language (XML) based API;
f. Instant Analytics Engine adapted for instant analytics at the point of sale including a Rule Engine, and the rules that the Marketing team sets for instant analytics and executes them at the time of billing to achieve targeted offers in an instant fashion.

8. A mobile phone based mobile customer relationship and loyalty servicing system as claimed in claim 1 wherein said server component may comprise:
i) Analytics Engine adapted to generate insights based on trends of activities;
ii) Campaigns Engine adapted to assimilate various campaigns and integrated with the rest of the MCRLP system or used separately;
iii) Rule Authoring Framework adapted for instant analytics to runs on the Client requiring the rules to be written in a particular format.

9. A mobile phone based mobile customer relationship and loyalty servicing system as claimed in claim 1 adapted for (i) immediate communication including enabling instant connect with the customer, higher interactivity and impulse purchase behaviour and (ii) instant analytics enabling real time capturing of data and its use to run instant analytics at the point of sale itself based on variables comprising of (a) Current Purchase, (b) Customer Demographics and Scores, (c) Environment Information, and (d) Inventory Information, said system said adapted to generate instant outcomes consisting of Vouchers and other actions that are communicated to the customer for instant redemption

10. A mobile phone based mobile customer relationship and loyalty servicing system as claimed in claim 1 comprising code based validation of mobile numbers including voucher validation and security mechanism preferably the voucher code is generated such that the code can be validated even when the network is not reachable/connected and thus enabling redemption of points and vouchers in a secure fashion in both connected and disconnected states.

11. A mobile phone based mobile customer relationship and loyalty servicing system as claimed in claim 1 comprising of the Client component that integrates with the Point of Sale system at the billing terminal using either software API based integration requiring customizations of the Point of Sale software, or by scraping the data from the screen without any modifications to the Point of Sale system.

12. A mobile phone based mobile customer relationship and loyalty servicing system as claimed in claim 1 comprising means for providing customer preferences for receiving communications, provision of alternative forms of generosity, milestone based programs, and instant analytics and vouchering.

13. A mobile phone based mobile customer relationship and loyalty servicing system as claimed in claim 1 wherein said means at the retail/sales outlets comprises selectively of additional hardware as follows:
a. Data Entry Machines at the retail/sales counter including communication instruments to receive calls from the user and identify them appropriately;
b. Data Entry Machines may scan the mobile directly through near-field communication technology such as femtocells, or radio frequency tags that are pre-associated with the mobile numbers at the time of customer registration. Any device that can either identify the mobile (IMEI number, IMSI number) or a pre-associated tag for the mobile may be used.
c. Data Entry Machines that contains means for generating and sending unique bar codes through SMS, and subsequently scanning them for entry into the system.

14. A method of mobile phone based mobile customer relationship and loyalty servicing involving the system as claimed in claim 1 comprising:
A) Activation at the client component involving the following steps:
i) The mobile number of the customer is entered by the cashier either manually, or through other automated means such as a PIN entering devices, an incoming phone which can identify the caller or hardware appendages as may be used for data entry;
ii) carrying out data availability check;
iii) capturing the data into the MCRLP Client system through the integration means;
iv) in the instance the customer who is the target of the current process, is marked “unsynchronized” in the local database, it means the said customer doesn't have a globally unique ID in the system, which then needs to be generated;
v) carrying out data validation step including voucher validation in case the process requires validation;
vi) in case the Client is in the disconnected state, the changes are cached in the local database, and uploaded whenever a sync is done (either on scheduled events, or manually);
vii) at this point any instant analytics can be run to generate dynamic vouchers for the user.
B) Activation at the Server component involving the following steps:
i) validating the data from the MCRLP Client component, cleaning up, and then adding or updating in the database as required;
ii) Any configuration defined by the client is respected, as the bills are stored for data-warehousing purpose, and points calculation is done, the functionality of the MCRLP Server is made very dynamic using the simple mechanisms including “Listeners” and “Trackers”.
iii) Executing listeners with the relevant supplied data on the occurrence of any Event including Customer Registration, Billing, Voucher Issue, Voucher Redemptions, Customer Referral and the like
iv) tracking the actions of a particular user and generate cumulative aggregates of various quantities for particular periods of time with or without integration with listeners including extraction of data required to be to be tracked involving preferably templates for capturing this data from the information supplied to listeners; storing the thus extracted data in a separate structured location to facilitate aggregating and calculating the same preferably defining threshold values for cumulative aggregates, and subsequently performing certain actions on the threshold values being exceeded and finally enabling the same through “Listeners” defined above.

15. A method of mobile phone based mobile customer relationship and loyalty servicing as claimed in claim 14 comprising carrying out campaign functionalities and incentive referral programs in relation to the above stated steps.

16. A mobile phone based mobile customer relationship and loyalty servicing system and a method of mobile phone based mobile customer relationship and loyalty servicing involving said system as substantially hereindescribed with reference to the accompanying illustrative drawings.
